(19) United States
(12) Patent Application Publication
(10) Pub. No.: US 2010/0134071 A1
(43) Pub. Date: Jun. 3, 2010

(54) BATTERY CHARGER CIRCUIT OPERATED FROM A THREE-PHASE NETWORK

(76) Inventor: Andras Fazakas, Budapest (HU)

Correspondence Address: FITCH, EVEN, TABIN & FLANNERY, P. O. BOX 18415, WASHINGTON, DC, 20036, US

(21) Appl. No.: 12/597,423

(22) PCT Filed: Apr. 24, 2008
(86) PCT No.: PCT/HU2008/000037

§ 371 Date: Oct. 23, 2009

(30) Foreign Application Priority Data
Apr. 24, 2007 (HU) P07700300

(51) Int. Cl. H02J 7/02

(52) U.S. Cl. 320/137

(57) ABSTRACT

Battery charger circuit operated from a three-phase network, comprising a three phase mains transformer with three secondary windings and three parallel connected pairs of series diodes, wherein the central interconnection lines of each of the series pairs of diodes are connected to respective end terminals of an associated one of the three secondary windings of the transformer, and the battery charger circuit comprises three similar circuits each of them is associated with a respective phase, each of the similar circuits comprises a permanently connected electrolytic capacitor (CR1, CS1, CT1) and a diode (DR, DS, DT) in parallel with the capacitor, wherein one end of the similar circuits is connected to the other terminal of the secondary winding (S1, S2, S3) of the associated phase, and the other ends of the similar circuits are interconnected.

The invention relates to a battery charger circuit operated from a three-phase network, comprising a three phase mains transformer with three secondary windings and three parallel connected pairs of series diodes, wherein the central interconnection lines of each of the series pairs of diodes are connected to respective end terminals of an associated one of the three secondary windings of the transformer.

The charging of batteries with higher storage capacity is generally solved by using an available three-phase mains supply, and several types of three-phase battery chargers are commercially available. In a classic solution the output terminals of the secondary phase windings of the three-phase transformer are coupled to respective bridge rectifiers that can be connected in parallel at their DC side i.e. by the interconnection of their DC output terminals, and the so obtained direct current voltage is used for supplying a classic battery charger designed according to the actual charging tasks.

In the international publication WO 01/06614 a battery charger circuit is described, wherein the momentary charging voltage is formed the vectorial sum of the voltage of a charged electrolytic capacitor and of an energized inductance constituted preferably by the secondary winding of a mains transformer. The circuit utilizes both half periods of the alternating mains voltage and provides an unique high current charging. The fact that one component of the output voltage is constituted by the voltage of a charged capacitor renders the charging process flexible, since the operation of the circuit cannot be damaged by a possible short-circuit of the battery to be charged, and the charging process is satisfactorily controlled by the value of the terminal voltage of the battery. FIG. 6 of this international publication shows three charging circuits fed from the respective secondary windings of three transformers, wherein one of the charging circuits is permanently connected and the other two charging circuits can be activated by two pairs of jointly controlled thyristors. The task of using such a solution is to enable the control of the charging power according to the actual demand for charging energy.

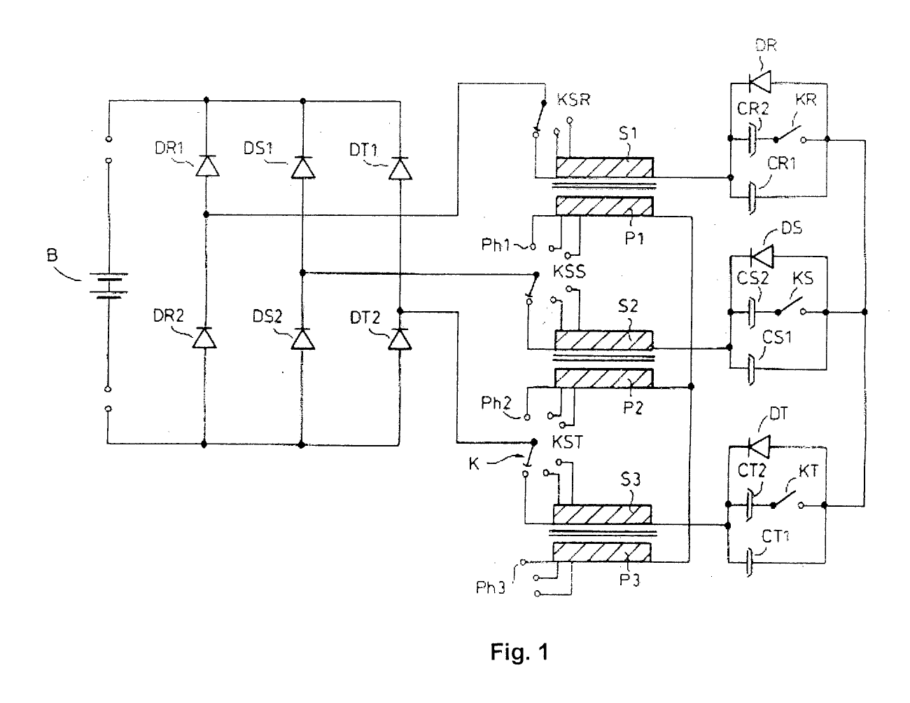

Besides several advantages of that solution one drawback lies in that in that form the circuit cannot be operated from a three-phase mains network. A correct three-phase charger can be obtained if three charger circuits each designed according to FIG. 1 or FIG. 4 of the cited publication would be used and supplied from respective phases of a three-phase mains, wherein the DC outputs of the chargers would be jointly coupled to the battery. In such three-phase chargers, however, for each phase respective pairs of electrolytic capacitors and a pair of diodes should be used (in case of need for adjustment, further pairs of such capacitors and corresponding number of electronic switches for connecting the associated further capacitors would be necessary). Of the listed components the electrolytic capacitors with high capacitance value have large size and they are expensive and the same applies to the semiconductor switches and to the diodes with high forward current. Because of these properties the supply of the cited single-phase battery chargers from a three-phase mains network would have large size and would be connected with high costs, although the charger circuit itself has preferable properties.

The control of such charger circuit can be solved expediently by varying the capacitance of the capacitors applied. In view of the existence of very intensive current pulses during the operation, the insertion of additional capacitors can be realized only by using specific types of semiconductor switching circuits causing only slight limitation of the required current peaks. Such a specific semiconductor switching circuit is described in the international publication WO 2005/078888.

The object of the present invention is to provide a battery charging circuit that retains the preferred basic properties of the above referred known battery charger according to which the momentary charging voltage is provided by the vectorial sum of the voltages of a capacitor and of an inductance, and at the same time it allows the feeding from a three-phase mains network, and provides a substantial saving in the number of components that would be required if the number of components of a basic charger circuit were multiplied by three.

This objective has been solved by providing a battery charger circuit operated from a three-phase network that comprises a three-phase mains transformer with three secondary windings and three parallel connected pairs of series diodes, wherein the central interconnection lines of each of the series pairs of diodes are connected to respective end terminals of an associated one of the three secondary windings of the transformer, and according to the invention the charger circuit comprises three similar circuits wherein each of them is associated with a respective one of the three phases, each of these similar circuits comprises a permanently connected electrolytic capacitor and a diode in parallel with the capacitor, and one end of the similar circuits is connected to the other terminal of the secondary windings of the associated phase, and the other ends of the similar circuits are interconnected.

In a preferable embodiment each of the similar circuits further comprises in parallel with the permanently connected capacitor at least one further electrolytic capacitor and an electronic switch for connecting and disconnecting this further electrolytic capacitor in parallel with the associated permanently connected electrolytic capacitor, and the resulting capacitance in each of the similar circuits is substantially the same.

It is preferred if the capacitance of each electrolytic capacitors is at least 100 μF but it can also be chosen as high as several thousands of μF.

From the point of view of controlling the charging power it is preferable if the secondary windings of the three-phase transformer each have a plurality of tap points connected through respective switches to the associated diode pairs, and the switches are moved together.

One way of the voltage control is to use a three-phase transformer with primary windings each having a plurality of tap points.

The charging circuit according to the present invention provides optimum conditions for charging batteries with high storage capacity from the available three-phase mains network, and it has at the same time a smaller size and a reduced self-cost as those conventional battery chargers that can be chosen for similar charging tasks.

The invention will now be described in connection with preferable embodiments, wherein reference will be made to the accompanying drawings. In the drawing:

FIG. 1 shows the circuit diagram of a preferred embodiment of the battery charger according to the invention, and

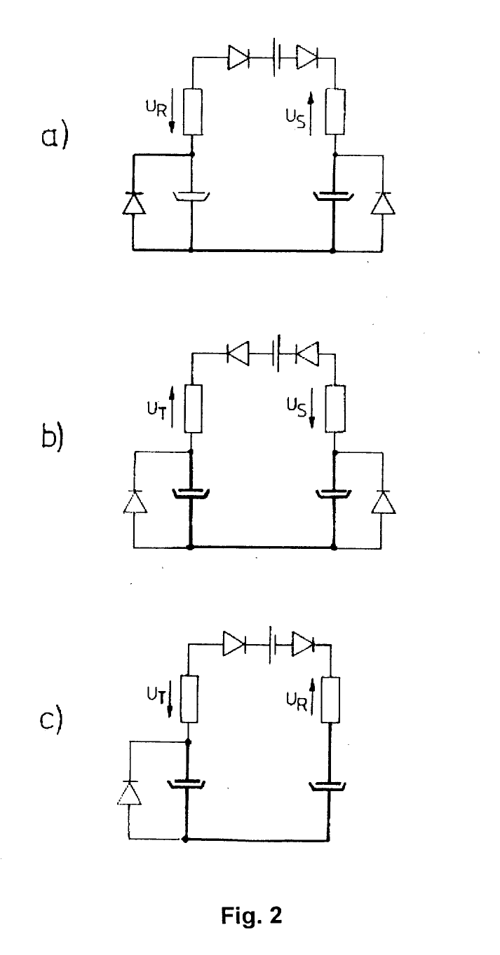

FIG. 2 comprises simplified diagrams a, b and c that assist understanding the operation.

The battery charger circuit shown in FIG. 1 comprises a three-phase transformer with primary windings P1, P2 and P3 and secondary windings S1, S2 and S3. The primary windings P1, P2 and P3 are connected in a star circuit and coupled to phase lines Ph1, Ph2 and Ph3 of a three-phase mains network. For regulating the secondary voltage the secondary windings S1, S2 and S3 are each provided with a plurality of tap terminals coupled to a multi-pole switch K, the poles having a common control moving element. The switch K comprises moving contacts KSR, KSS and KST corresponding to the three phase lines R, S and T of the mains network. The moving contact KSR that is associated with the phase line R is connected to a common connection line of series diodes DR1 and DR2, the moving contact KSS is coupled to a common line of series diodes DS1 and DS2 and finally the moving contact KST is coupled to a common line of series diodes DT1 and DT2. The respective other end terminals of the three pairs of diodes are connected to each other and coupled to the terminals of battery B to be charged.

The end terminals of the secondary windings S1, S2 and S3 of the three-phase transformer which are at the opposite end relative to that coupled to the switch K are connected to a respective one of three similar circuits, each comprising a permanently connected electrolytic capacitor with high capacitance value and a plurality of further electrolytic capacitors that can be connected in parallel with the permanent capacitor. In each circuit the capacitors that can be inserted are symbolized with a single capacitor and a series switch. Accordingly, phase line R is associated with a permanent capacitor CR1 and capacitor CR2 that can be switched on and off with switch KR and diode DR. Phase line S is associated with a permanent capacitor CS1 and capacitor CS2 that can be switched on and off with switch KS and diode DS, finally phase line T is associated with a permanent capacitor CT1 and capacitor CT2 that can be switched on and off with switch KT and diode DT. The permanent capacitors are also associated with respective switches (not shown) for limiting the current rise when the system is first energized and the capacitors are still discharged by limiting elements associated with these semiconductor switches.

It is important to note that the switches KR, KS and KT are controlled at the same time in order to attain respective identical capacitance values in all the three circuits and if that capacitance is changed, that should take place together for the three phases. These controlled switches are designed preferably as disclosed in the previously referred international publication WO 2005/078888, and each of them comprises a series inductance that limits the steepness of the initial current rise. The end terminals of the three circuits opposite to those coupled to the secondary windings S1, S2 and S3 are interconnected.

For understanding the operation of the three-phase charger according to the invention it should be taken into account that in each charging period the voltage across the battery B is equal with the sum of the forward bias voltage of the open one of the diodes, the momentary voltage on the associated secondary winding and the voltage on the inserted capacitors. In the two momentarily open branches the direction of the flow of the current must have the same sense which is ensured by the connection of the diodes as shown in the drawing. When the voltage of the momentarily active branches would proceed to exceed the battery voltage, the energies stored in the electrolytic capacitor and in the secondary winding of the associated branch will intensively charge the battery B, while the mentioned voltage balance is permanently maintained. The conditions for charge will be satisfied three times in each period of the mains voltage, and the duration of the charging sections (the flowing angle) will greatly depend on the voltage on the battery B i.e. on its state of charge. The circuit arrangement is therefore and to some extent self-regulating, the charging takes the longer out of the full period time when the voltage on the battery B is the smallest i.e. when there is the highest demand for being charged. With increasing battery voltage (i.e. with increased amount of charge stored) the active charging period sections will be shorter and the charging process will become gentler. Diagrams a., b. and c. on FIG. 2 indicate the directions of the voltages and currents prevailing during the active periods, and the momentarily active circuit elements have been drawn by heavy lines. In each charging period section the current flows through the inductance of two of the phases and always two electrolytic capacitors delivers (receives) energy. In certain instances instead of the capacitor the current flows through the diode connected in parallel with this capacitor which closes the circuit and prevents the reversal of polarity on the electrolytic capacitor.

In the three-phase charger circuit the number of the electrolytic capacitors, diodes and controlled switches is just the half of the number of the same elements which would be required in the previously mentioned classic charger design.

With the charging circuit according to the invention there are several ways for changing the charging parameters. The permanent capacitors CR1, CS1 and CT1 have very high capacitance, their value is between about 100-5000 μF and the optional capacitors CR2, CS2 and CT2 have equally high capacitance values. By increasing the storage capacity the energy used for charging the battery B in each period can be increased. The duration of the charging periods can be influenced by changing the voltages on the secondary windings S1, S2 and S3 by the simultaneous operation of the switches KSR, KSS and KST. The charging power can also be changed by the control of the excitation of the primary windings P1, P2 and P3 which can be made by several ways. The simplest of all excitation controls is if the number of the active turns in the primary windings is changed in discrete steps by a further switch and by providing a plurality of tap point in the primary windings, not shown in the drawing.

The three-phase charging circuit according to the invention has in addition to the high-power rating a comparatively simple circuit design and creates optimum conditions for charging the battery B with high storage capacity. A separate advantage comes from the possibility for controlling the charging power and the comparatively small size which has been made possible by reducing the number of components and accessories with larger size.

1. Battery charger circuit operated from a three-phase network, comprising a three phase mains transformer with three secondary windings and three parallel connected pairs of series diodes, wherein the central interconnection lines of each of the series pairs of diodes are connected to respective end terminals of an associated one of the three secondary windings of the transformer, characterized by comprising three similar circuits each being associated with a respective one of said phases, said similar circuits each comprising a permanently connected electrolytic capacitor (CR1, CS1, CT1) and a diode (DR, DS, DT) in parallel with said capacitor, one end of said similar circuits being connected to the other terminal of the secondary windings (S1, S2, S3) of the associated phase, and the other ends of said similar circuits are interconnected.

2. The battery charger circuit as claimed in claim 1, wherein each of said similar circuits further comprises in parallel with said permanently connected capacitors (CR1, CS1, CT1) at least one further electrolytic capacitor (CR2, CS2, CT2) and an electronic switch (KR, KS, KT) for connecting and disconnecting said further electrolytic capacitor in parallel with said permanently connected electrolytic capacitor, and the resulting capacitance in each of said similar circuits is substantially the same.

3. The battery charger circuit as claimed in claim 1, wherein the capacitance of each of said electrolytic capacitors is at least 100 μF.

4. The battery charger circuit as claimed in claim 1, wherein said secondary windings (S1, S2, S3) of said three-phase transformer each have a plurality of tap points connected through respective switches (KSR, KSS, KST) to said diode pairs, and said switches being moved together.

5. The battery charger circuit as claimed in claim 1, wherein three-phase transformer comprises primary windings (P1, P2, P3) each having a plurality of tap points.
